(19) United States
(12) Patent Application Publication
(10) Pub. No.: US 2026/0148313 A1
(43) Pub. Date: May 28, 2026

(54) ACCOUNTING OF DIGITAL ASSETS

(71) Applicant: SAP SE, Walldorf (DE)

(72) Inventors: Stefan SCHMID, Rauenberg (DE); Srinivasa Raghavan V, Chennai (IN); Madhusudan SAHU, Bangalore (IN); Harshith Kumar Reddy BUSIREDDY, Bangalore (IN); Prathiksha K S, Bangalore (IN); Ashutosh Ganeshrao THORAT, Amravati (IN); Sumithra SUDHARSANAM, Bangalore (IN); Sissi RUTHE, Hamburg (DE); Bernhard SCHWEIZER, Nußloch (DE); Brit PANZER, Mannheim (DE)

(21) Appl. No.: 18/956,285

(22) Filed: Nov. 22, 2024

(51) Int. Cl. G06Q 40/12; G06Q 20/38

(52) U.S. Cl. CPC G06Q 40/12; G06Q 20/381

(57) ABSTRACT

Embodiments are described for a digital currency hub (DCH) comprising a memory and a processor. The processor is configured to receive a confirmation of a transaction. The confirmation indicates a first amount in a first cryptocurrency (the “transaction amount”) and a second amount in a second cryptocurrency (the “network fee”). The processor is further configured to adjust a first position corresponding to the first cryptocurrency based on the first amount and adjust a second position corresponding to the second cryptocurrency based on the second amount. The adjustments can be pro-rata. The processor is further configured to calculate gains or losses based on the adjustments of the positions. In some embodiments, the DCH enables the ERP system to handle cryptocurrencies according to the rules of various accounting principles in parallel, because the ERP system is not compatible or capable of handling digital transactions with respect to accounting regulations directly.

### BACKGROUND

An enterprise resource planning (ERP) system may be configured to manage assets for a corporation. In some embodiments, the assets can be represented in a fiat currency, such as U.S. dollar. In other embodiments, the assets can be digital assets including stable coins such as USDC or USDT, or native cryptocurrencies such as bitcoin or ether. However, it is challenging for the ERP system to manage the digital assets because the ERP system may not be able to process transactions of the digital assets.

### SUMMARY

Some embodiments of this disclosure include apparatuses and methods for enabling an enterprise resource planning (ERP) system to process digital assets transactions, and more specifically, providing an accounting system to process the digital assets transaction.

Some embodiments of this disclosure relate to a digital currency hub (DCH) comprising a memory and a processor. The processor is configured to receive a confirmation of a transaction. The confirmation indicates a first amount in a first cryptocurrency (the “transaction amount”) and a second amount in a second cryptocurrency (the “network fee”). The processor is further configured to adjust a first position corresponding to the first cryptocurrency based on the first amount and adjust a second position corresponding to the second cryptocurrency based on the second amount pro-rata. The processor is further configured to create a first accounting transaction based on the adjustments of the first position and a second accounting transaction based on the adjustments of the second position. The processor is further configured to transmit an aggregated accounting transaction including the first and the second accounting transactions to an ERP system on an aggregated level.

Some embodiments of this disclosure relate to a method for a DCH. The method includes receiving a confirmation of a transaction. The confirmation indicates a first amount in a first cryptocurrency and a second amount in a second cryptocurrency. The method further includes adjusting a first position corresponding to the first cryptocurrency based on the first amount and adjusting a second position corresponding to the second cryptocurrency based on the second amount pro-rata. The method further includes creating a first accounting transaction based on the adjustments of the first position and a second accounting transaction based on the adjustments of the second position. The method further includes transmitting an aggregated accounting transaction including the first and the second accounting transactions to an ERP system.

Some embodiments of this disclosure relate to a non-transitory computer-readable medium (CRM) including instructions to, upon execution of the instructions by one or more processors of a DCH, cause the DCH to perform operations. The operations include receiving a confirmation of a transaction. The confirmation indicates a first amount in a first cryptocurrency and a second amount in a second cryptocurrency. The operations further include adjusting a first position corresponding to the first cryptocurrency based on the first amount and adjusting a second position corresponding to the second cryptocurrency based on the second amount pro-rata. The operations further include creating a first accounting transaction based on the adjustments of the first position and a second accounting transaction based on the adjustments of the second position. The operations further include transmitting an aggregated accounting transaction including the first and the second accounting transactions to an ERP system.

This Summary is provided merely for purposes of illustrating some embodiments to provide an understanding of the subject matter described herein. Accordingly, the above-described features are merely examples and should not be construed to narrow the scope or spirit of the subject matter in this disclosure. Other features, embodiments, and advantages of this disclosure will become apparent from the following Detailed Description, Figures, and Claims.

### BRIEF DESCRIPTION OF THE FIGURES

The accompanying drawings, which are incorporated herein and form part of the specification, illustrate the present disclosure and, together with the description, further serve to explain the principles of the disclosure and enable a person of skill in the relevant art(s) to make and use the disclosure.

FIG. 1 illustrates an example system including a digital currency hub (DCH), according to some embodiments of the disclosure.

FIG. 2 illustrates a block diagram of the DCH, according to some embodiments of the disclosure.

FIG. 3 illustrates an example method of processing a digital asset transaction, according to some embodiments of the disclosure.

FIG. 4 illustrates an example method of updating positions of a book, according to some embodiments of the disclosure.

FIG. 5 illustrates an example method of reporting an accounting transaction, according to embodiments of the disclosure.

FIG. 6 illustrates an example computer system for implementing some embodiments of the disclosure or portion(s) thereof.

The present disclosure is described with reference to the accompanying drawings. In the drawings, generally, like reference numbers indicate identical or functionally similar elements. Additionally, generally, the left-most digit(s) of a reference number identifies the drawing in which the reference number first appears.

### DETAILED DESCRIPTION

Some embodiments of this disclosure include apparatus, system, computer program product, and method embodiments for enabling an enterprise resource planning (ERP) system to process digital assets transactions.

In some embodiments, the ERP system can manage assets for a corporation or an organization. For example, the ERP system can connect with banks and/or other financial institutions. Thus, the ERP system can track and record funds available to the corporation as well as all inflows and outflows of cash. In some embodiments, the ERP system can provide real-time visibility into cash positions, bank balances, and liquidity. The ERP system can also ensure that transactions including receipts, payments, and bank transfers are accurately recorded and integrated with financial statements. In some embodiments, the ERP system can manage positions in a book based on transactions. For example, if the corporation pays out to a business partner with $5,000 U.S. dollar, the ERP system can adjust a position of the U.S. dollar by deducting the $5,000 U.S. dollar in corresponding books.

In some embodiments, the corporation may have assets other than fiat currencies, such as the U.S. dollar. For example, the corporation may hold positions in digital assets including stable coins such as USDC or USDT, or native cryptocurrencies such as bitcoin or ether. However, the ERP system may not be able to manage the digital assets directly. For example, fiat currencies, such as U.S. dollars, normally have 2 digits after the decimal point. In contrast, cryptocurrencies may have 19 or more digits after the decimal point. Thus, the ERP system may not have the accuracy required to manage the digital assets in cryptocurrencies. Furthermore, the ERP system may not have a direct connection with a block-chain network that realizes digital transactions in cryptocurrencies. Thus, the ERP system may not be able to obtain and record necessary information of the digital transactions. For example, the digital transactions may incur network fees and the network fees may be paid in a native cryptocurrency of the block-chain network. However, the ERP system may not monitor or manage positions in cryptocurrencies, including the native cryptocurrency. Thus, the ERP system may not be able to record the network fees of the transactions.

In some embodiments, a transitional layer can be used to bridge the gap between the ERP system and the cryptocurrency network. For example, the transitional layer can be a digital currency hub (DCH). In some embodiments, the DCH may receive confirmation of transactions from the block-chain network. The confirmation may include information of the transaction, such as an amount of a cryptocurrency being disbursed or received, a transaction ID, such as a hash number, addresses of paying and receiving wallets, network fee being paid to the blockchain network, and so on. The DCH can then for each book adjust positions of digital assets based on the confirmation and generate an accounting transactions. Finally, the DCH can transmit the accounting transactions on an aggregated basis to the ERP system. In some embodiments, the aggregated accounting transactions are based on a fiat currency so that the ERP system can process the aggregated accounting transactions.

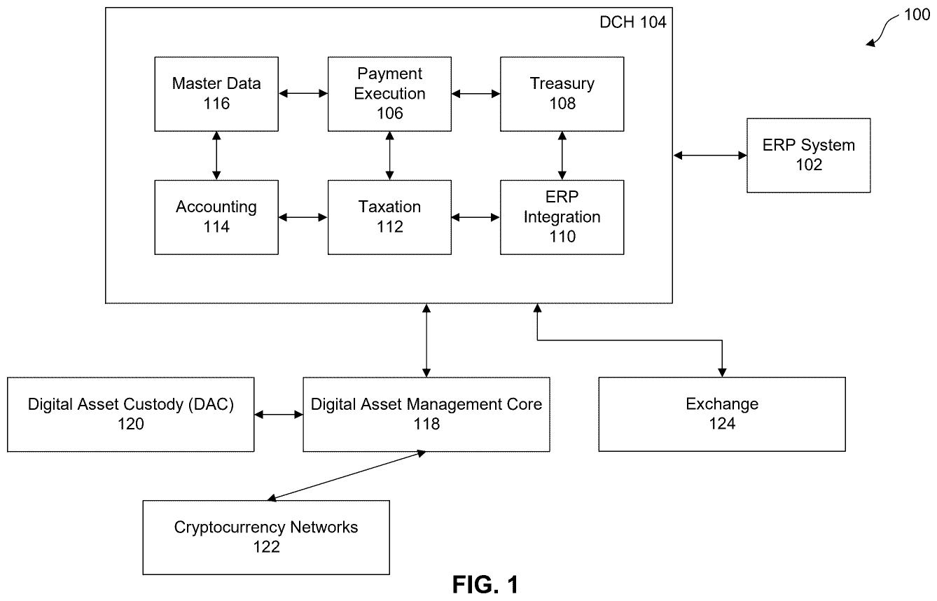

FIG. 1 illustrates an example system 100 including a DCH, according to some embodiments of the disclosure. The example system 100 is provided for the purpose of illustration only and does not limit the disclosed embodiments. The example system 100 may include, but is not limited to, an ERP system 102, a DCH 104, a digital asset management core 118, a digital asset custody (DAC) 120, cryptocurrency networks 122, and an exchange 124. The DCH 104 may further include a payment execution 106, a treasury 108, an ERP integration 110, a taxation 112, an accounting 114, and a master data 116, which are connected to each other. In some embodiments, the ERP system 102, the DCH 104, the digital asset management core 118, and the DAC 120 may include, but is not limited to, computer systems, servers, cloud systems, cloud servers, laptops, desktops, personal computers, databases, user equipment, and the like. In some embodiments, the DCH 104, the digital asset management core 118, and the DAC 120 may be integrated into a physical hardware. The physical hardware can be referred to as a combined DCH including the DCH 104, the digital asset management core 118, and the DAC 120. In some embodiments, the exchange 124 may include trading platforms such as Coinbase™, Binance™, or Kraken™.

In some embodiments, the ERP system 102 is a comprehensive software platform used by an organization, such as a corporation or a company, to manage and integrate core business processes across various departments in real-time. For example, the ERP system 102 can manage assets using centralized systems, such as banks and financial institutions, as discussed above. On the other hand, the cryptocurrency networks 122 are decentralized and can facilitate transactions in a decentralized way. In some embodiments, the DCH 104, coupled with the digital asset management core 118 and the DAC 120, can enable the ERP system 102 to process transactions from the cryptocurrency networks 122.

In some embodiments, the ERP system 102 may manage assets such as accounts in fiat currencies. For example, the ERP system 102 may manage bank accounts in U.S. dollars. When the organization pays out or receives funds in a bank account, the ERP system can adjust positions corresponding to the fiat currency. In some embodiments, the organization may also hold positions in digital assets, such as cryptocurrencies. In such a case, the ERP system may also be used to manage the digital assets. However, because of the incompatibility discussed above, such as the accuracy issue, the ERP system may manage the digital assets based on positions in the fiat currency. For example, the organization may hold 1 bitcoin purchased at $20,000. In such a case, the ERP system may record that the position of bitcoin is $ 20,000, rather than 1 bitcoin. In some embodiments, the price of the bitcoin may fluctuate from time to time. Thus, depending on the time the bitcoin is purchased and the time the bitcoin is sold, a transaction may result in a gain or a loss. For example, if that 1 bitcoin was later sold at a price of $60,000, the position of the bitcoin will be adjusted to $0 because there is no more bitcoin in the position. However, a position of the U.S. dollar will increase by $60,000. The ERP system can compare the $60,000 adjustment to an earlier adjustment when purchasing the 1 bitcoin, which is deducting $ 20,000. Thus, the ERP system can determine that a gain of $40,000 is realized.

In some embodiments, the digital asset management core 118 may receive a confirmation of a transaction from the cryptocurrency networks 122. The confirmation may include information regarding the transaction, such as an amount of a cryptocurrency being disbursed or received, a transaction ID, such as a hash number, addresses of paying and receiving wallets, network fee being paid to the blockchain network, and so on. The digital asset management core 118 may then forward the confirmation to the DCH 104. In some embodiments, the treasury 108 may receive the confirmation and create a purchase or a sale based on the confirmation. For example, if the transaction is an incoming transaction, the treasury 108 may create a purchase. The treasury may also enhance the purchase by adding trading information such as an amount paid in fiat currency to purchase a cryptocurrency, and an amount paid in fiat currency for a trading fee. In some embodiments, the treasury 108 can obtain the trading information from a user. For example, the user can input the trading information to the DCH 104. In some embodiments, the treasury 108 can also obtain the trading information from the exchange 124 where the amount in cryptocurrency has been purchased. For example, the treasury 108 may transmit a request, such as a query, to the exchange 124. The request may include the transaction ID and the addresses of paying and receiving wallets so that the transaction can be located. The treasury may then receive the trading information from the exchange 124.

In some embodiments, the accounting 114 may also receive the confirmation of the transaction. In addition, the accounting 114 may receive the purchase or the sale created by the treasury 108 from the treasury 108. In some embodiments, the accounting 114 may adjust positions of corresponding cryptocurrencies and report to the ERP system 102, as discussed more in detail below.

In some embodiments, the master data 116 includes information of business partners of the organization that uses the ERP system 102. For example, the information may include a preferred method of payments, a cryptocurrency, a cryptocurrency network, and one or more digital wallet addresses. In some embodiments, the payment execution 106 can execute payments to and receive payments from the business partners. In some embodiments, the ERP integration 110 can enable communications with the ERP system 102. For example, the ERP integration 110 can convert document format of documents received from the ERP system 102, such as payment requests. For another example, the ERP integration 110 can convert document format of documents to be transmitted to the ERP system 102, such as an accounting transaction. In some embodiments, taxation 112 may generate statutory reporting to the organization or government entities

In some embodiments, the digital asset management core 118 may directly connect with the cryptocurrency networks 122. For example, the digital asset management core 118 may manage inventory of crypto assets and crypto transactions, such as digital wallets, transaction logs, transaction creation, approval & outbox, exchange links, and so on. In some embodiments, the digital asset management core 118 may broadcast payment information to participants of the cryptocurrency networks 122 so that the payment is complete and the payment information is added to a new block. In some embodiments, the DAC 120 may perform private key management, transaction signing, and other functions of transaction in the cryptocurrency networks 122.

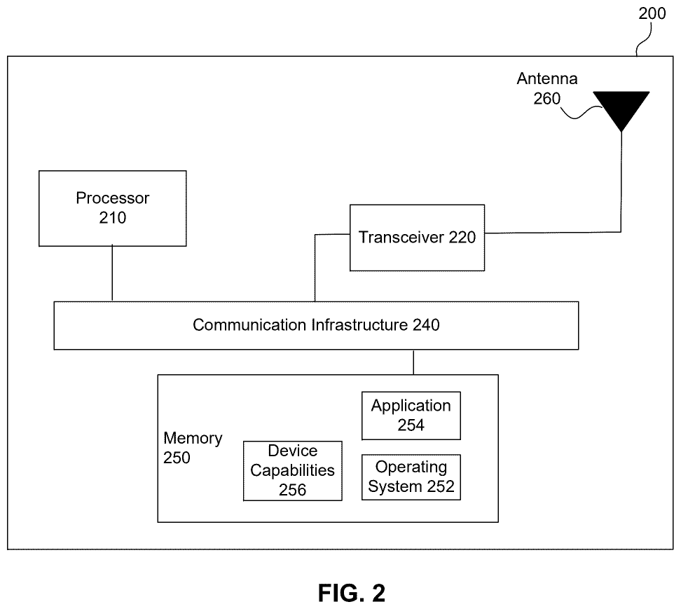

FIG. 2 illustrates a block diagram of the DCH, according to some embodiments of the disclosure. The electronic device 200 may be any of the electronic devices (e.g., the DCH 104, the digital asset management core 118, and the DAC 120, or a combination thereof of FIG. 1) of the system 100. The electronic device 200 includes a processor 210, one or more transceivers 220, a communication infrastructure 240, a memory 250, an operating system 252, an application 254, device capabilities 256, and antenna 260. Illustrated systems are provided as exemplary parts of electronic device 200, and electronic device 200 may include other circuit(s) and subsystem(s). Also, although the systems of electronic device 200 are illustrated as separate components, the embodiments of this disclosure may include any combination of these, e.g., less, or more components.

The memory 250 may include random access memory (RAM) and/or cache, and may include control logic (e.g., computer software) and/or data. The memory 250 may include other storage devices or memory. According to some examples, the operating system 252 may be stored in the memory 250. The operating system 252 may manage transfer of data from the memory 250 and/or the one or more applications 254 to the processor 210 and/or the one or more transceivers 220. In some examples, the operating system 252 maintains one or more network protocol stacks (e.g., Internet protocol stack, cellular protocol stack, and the like) that may include a number of logical layers. At corresponding layers of the protocol stack, the operating system 252 includes control mechanisms and data structures to perform the functions associated with that layer.

According to some examples, the application 254 may be stored in the memory 250. The application 254 may include applications (e.g., user applications) used by the electronic device 200 and/or a user of the electronic device 200. In some embodiments, the device capabilities 256 may be stored in the memory 250.

The electronic device 200 may also include the communication infrastructure 240. The communication infrastructure 240 provides communication between, for example, the processor 210, the one or more transceivers 220, and the memory 250. In some implementations, the communication infrastructure 240 may be a bus.

The processor 210, alone, or together with instructions stored in the memory 250 performs operations enabling electronic device 200 of the system 100 to implement mechanisms for enabling an ERP system to process digital assets transactions, as described herein. Alternatively, or additionally, the processor 210 can be “hard coded” to implement mechanisms for enabling an ERP system to process digital assets transactions, as described herein.

The one or more transceivers 220 transmit and receive communications signals support mechanisms for enabling an ERP system to process digital assets transactions. Additionally, the one or more transceivers 220 transmit and receive communications signals that support mechanisms for measuring communication link(s), generating and transmitting system information and data, and receiving the system information and data. According to some embodiments, the one or more transceivers 220 may be coupled to the antenna 260 to wirelessly transmit and receive the communication signals. The antenna 260 may include one or more antennas that may be the same or different types and can form one or more antenna ports. In some embodiments, the antenna 260 can be replaced or used in combination with wired communication interferences, such as Ethernet, Universal Serial Bus (USB), serial port, serial advanced technology attachment (SATA), and fiber optic interferences. The one or more transceivers 220 allow electronic device 200 to communicate with other devices that may be wired and/or wireless. In some examples, the one or more transceivers 220 may include processors, controllers, radios, sockets, plugs, buffers, and like circuits/devices used for connecting to and communication on networks. According to some examples, the one or more transceivers 220 include one or more circuits to connect to and communicate on wired and/or wireless networks.

According to some embodiments of this disclosure, the one or more transceivers 220 may include a cellular subsystem, a WLAN subsystem, and/or a Bluetooth™ subsystem, each including its own radio transceiver and protocol(s) as will be understood by those skilled in the arts based on the discussion provided herein. In some implementations, the one or more transceivers 220 may include more or fewer systems for communicating with other devices.

In some examples, the one or more the transceivers 220 may include one or more circuits (including a WLAN transceiver) to enable connection(s) and communication over WLAN networks such as, but not limited to, networks based on standards described in IEEE 802.11.

Additionally, or alternatively, the one or more the transceivers 220 may include one or more circuits (including a Bluetooth™ transceiver) to enable connection(s) and communication based on, for example, Bluetooth™ protocol, the Bluetooth™ Low Energy protocol, or the Bluetooth™ Low Energy Long Range protocol. For example, the transceiver 220 may include a Bluetooth™ transceiver. Additionally, the one or more the transceivers 220 may include one or more circuits (including a cellular transceiver) for connecting to and communicating on cellular networks.

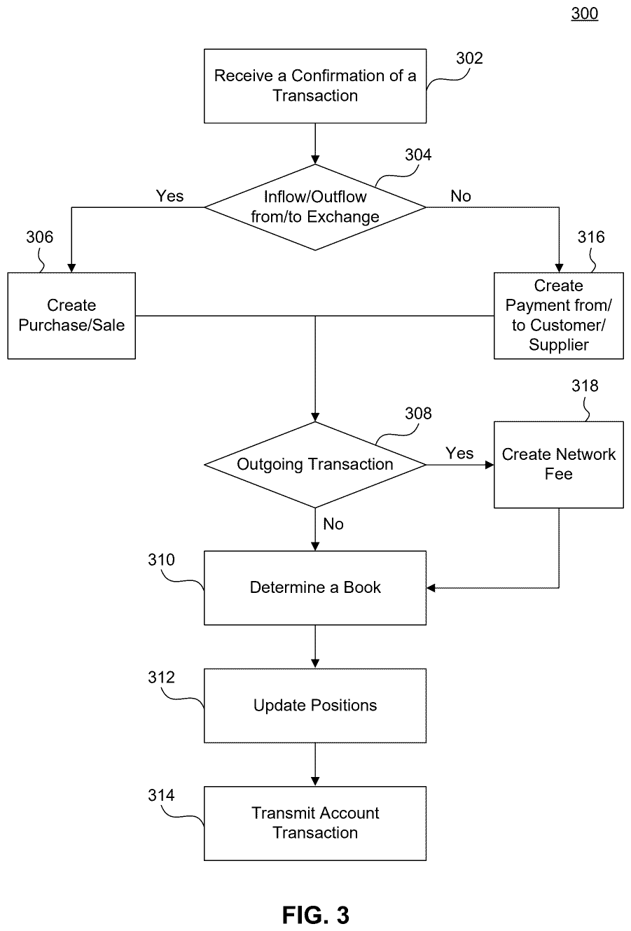

As discussed in more detail below with respect to FIGS. 3-6, processor 210 may implement different mechanisms for enabling an ERP system to process digital assets transactions as discussed with respect to the system 100 of FIG. 1.

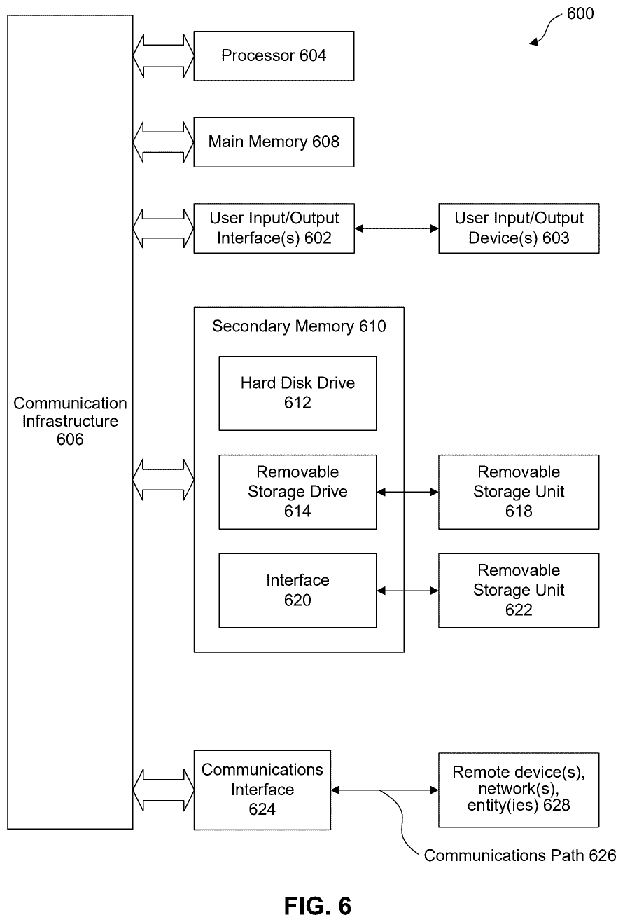

FIG. 3 illustrates an example method 300 of processing a digital asset transaction, according to some embodiments of the disclosure. As a convenience and not a limitation, FIG. 3 may be described with regard to elements of FIGS. 1, 2, and 6. The example method 300 may represent the operation of devices (e.g., the ERP system 102, the DCH 104, the digital asset management core 118, the DAC 120, the cryptocurrency networks 122, or a combination thereof of FIG. 1) enabling an ERP system to process digital assets transactions. The example method 300 may also be performed by computer system 600 of FIG. 6. But the example method 300 is not limited to the specific embodiments depicted in those figures and other systems may be used to perform the method, as will be understood by those skilled in the art. It is to be appreciated that not all operations may be needed, and the operations may not be performed in the same order as shown in FIG. 3.

At 302, a DCH, such as the DCH 104, receives a confirmation of a transaction. The confirmation may include information regarding the transaction, such as an amount of a cryptocurrency being disbursed or received, a transaction ID, such as a hash number, addresses of paying and receiving wallets, network fee being paid to the blockchain network, and so on. In some embodiments, the DCH 104 receives the confirmation from a digital asset management core, such as the digital asset management core 118. The digital asset management core may receive the confirmation from a cryptocurrency network, such as the cryptocurrency networks 122, and forward the confirmation to the confirmation to the DCH.

At 304, the DCH determines what type the transaction is. In some embodiments, the DCH may determine that the transaction is an inflow from or an outflow to an exchange, such as the exchange 124. For example, the inflow from the exchange may include purchasing cryptocurrencies and the outflow to the exchange may include selling cryptocurrencies. In such a case, the control moves to 306.

At 306, a treasury of the DCH, such as the treasury 108, creates a purchase or a sale based on whether the transaction is the inflow from the exchange or the outflow to the exchange. For example, if the transaction is the inflow from the exchange, the confirmation is directed to a purchase of a cryptocurrency. In such a case, the treasury creates a purchase describing the transaction. In addition, the treasury may enhance the purchase by adding trading information as discussed above in FIG. 1. For example, the trading information may include an amount paid in a fiat currency, such as the U.S. dollar, for purchasing the cryptocurrency and an amount paid in the fiat currency for trading fees for the transaction. In some embodiments, the trading fees are paid to the exchange. On the other hand, if the transaction is the outflow to the exchange, the confirmation is directed to a sale of a cryptocurrency. In such a case, the treasury creates a sale describing the transaction. The treasury may similarly enhance the sale by adding trading information, such as an amount received in a fiat currency, such as the U.S. dollar, for selling the cryptocurrency and an amount paid in the fiat currency for trading fees for the transaction. The trading information may also include a network fee incurred when selling the cryptocurrency. In some embodiments, the treasury sends the purchase or the sale to the accounting of the DCH.

At 308, the DCH determines whether the transaction is an outgoing transaction. For example, if the transaction is the inflow from the exchange, the control moves to 310. At 310, the DCH determines a book based on an accounting regulation. In some embodiments, the DCH may maintain various books corresponding to different accounting regulations, such as U.S. generally accepted accounting principles (US-GAAP), international financial reporting standards (IFRS), or other local regulations. The DCH may maintain a book for each applicable regulation. Furthermore, the DCH may determine that the transaction is applicable to all or some of books maintained by the DCH. In either case, the DCH may proceed for each applicable book. In some embodiment, the step 306 is performed by an accounting of the DCH, such as the accounting 114.

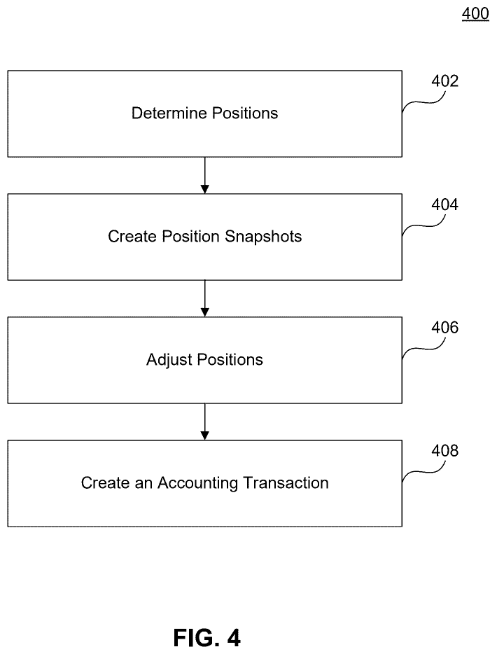

At 312, the DCH updates positions based on the transaction in each book determined in 306, as discussed more in detail in FIG. 4. In some embodiments, the DCH may maintain positions for one or more cryptocurrencies and one or more fiat currencies. The DCH may generate an accounting transaction based on the updated positions. The accounting transaction may indicate events of position changes. In some embodiment, the step 308 is performed by the accounting of the DCH, such as the accounting 114.

At 314, the DCH aggregates accounting transactions and transmits the aggregated accounting transactions to an ERP system, such as the ERP system 102. In some embodiments, the DCH transmits the aggregated accounting transactions via an ERP integration, such as the ERP integration 110.

Referring back to 304, the DCH may determine that the transaction does not correspond to an inflow or outflow from/to an Exchange. For example, the DCH may determine that the transaction is a payment received from a customer or a payment to a supplier. In such a case, the control moves to 316. At 316, the DCH creates a payment from the customer or a payment to the supplier. The control then moves to 308.

Referring back to 308, if the DCH determines that the transaction is an outgoing transaction, the control moves to 318. At 318, the DCH creates a network fee. In some embodiments, the network fee incurred from the transaction because the transaction is an outgoing transaction. The confirmation received at 302 may indicate the network fee. The network fee is in a native cryptocurrency like ether or bitcoin. The control then moves to 310.

At 310, the accounting of the DCH determines a book based on an accounting regulation as discussed above.

At 312, the accounting of the DCH updates positions based on the transaction and the purchase or the sale received from the treasury in each book determined in 306, as discussed more in detail in FIG. 4. The DCH performs similarly in 314 as discussed above.

FIG. 4 illustrates an example method 400 of updating positions of a book, according to some embodiments of the disclosure. As a convenience and not a limitation, FIG. 4 may be described with regard to elements of FIGS. 1, 2, and 6. The example method 400 may represent the operation of devices (e.g., the ERP system 102, the DCH 104, the digital asset management core 118, the DAC 120, the cryptocurrency networks 122, or a combination thereof of FIG. 1) enabling the ERP system to process digital assets transactions. The example method 400 may also be performed by computer system 600 of FIG. 6. But the example method 400 is not limited to the specific embodiments depicted in those figures and other systems may be used to perform the method, as will be understood by those skilled in the art. It is to be appreciated that not all operations may be needed, and the operations may not be performed in the same order as shown in FIG. 4. In some embodiments, the example method 400 discusses operations of 308 of FIG. 3.

At 402, the accounting of the DCH determines positions affected by the transaction. In some embodiments, if the transaction is an outgoing transaction of the stable cryptocurrency, the positions affected by the transaction may include a first position corresponding to a stable cryptocurrency (e.g., from the Purchase/sale as discussed in 306) and a second position corresponding to a native cryptocurrency (e.g., from the Network Fee as discussed in 318). For example, the first position may correspond to USDT. Since the transaction is outgoing, the first position will be deducted based on the transaction. In some embodiments, the stable cryptocurrency mains a one-to-one exchange rate with a fiat currency. For example, the USDT may maintain a one-to-one exchange rate with the U.S. dollar. Thus, there may not be a need to convert the USDT to the U.S. dollar. In other words, the first position can be maintained similarly to a position corresponding to the U.S. dollar. In some embodiments, the second position may correspond to ether. For example, the transaction may incur network fees that are paid in native cryptocurrencies, such as ether. Thus, even for the transaction of the stable cryptocurrency, the second position is also affected.

In some embodiments, the transaction may be a transaction in a native cryptocurrency. For example, the transaction may be an incoming transaction of bitcoin. In such a case, the positions affected by the transaction may include a third position corresponding to bitcoin. The third position is affected because an amount of bitcoin held by the organization increases since the transaction involves purchasing bitcoins.

At 404, the accounting of the DCH takes snapshots of positions determined in 402. For example, if the transaction is an outgoing transaction of the stable cryptocurrency, the accounting of the DCH takes snapshots of the first position and the second position. For another example, if the transaction is an incoming transaction of bitcoin, the accounting of the DCH takes snapshots of the third position. In some embodiments, the snapshots record the status of positions prior to processing the transaction. For example, if the transaction is an outgoing transaction of the stable cryptocurrency, the first position may decrease after the transaction is processed because the stable cryptocurrency is sold in the transaction. A snapshot of the first position may record an amount of the stable cryptocurrency prior to the transaction for future reference.

At 406, the accounting of the DCH adjusts the positions determined in 402. In some embodiments, if the transaction is an outgoing transaction of the stable cryptocurrency, the accounting of the DCH may adjust the first position and the second position. For example, the accounting of the DCH may determine an amount of the stable cryptocurrency sold in the transaction. As discussed above, the first position may be maintained in a fiat currency, such as the U.S. dollar, so that an ERP system, such as the ERP system 102, connecting to the DCH can understand and process. Since the stable cryptocurrency can maintain the one-to-one exchange rate with the U.S. dollar, the accounting of the DCH can adjust the first position by deducting the amount of the stable cryptocurrency sold in the transaction. On the other hand, the second position corresponds to a native cryptocurrency and is also maintained in the fiat currency. For example, the second position may correspond to ether. The organization may have acquired 1 unit of ether at a price of $400. Thus, the second position is currently at $400. In such a case, when adjusting the second position, the accounting of the DCH may adjust pro-rata. For example, the network fee of the transaction may be 0.1 ether. Thus 10% of the ether in the second position is to be deducted. Since the second position is currently at $400, the accounting of the DCH may adjust the second position to $360.

In some embodiments, if the transaction is an incoming transaction in a native cryptocurrency, such as bitcoin, the accounting of the DCH may adjust the third position. The accounting of the DCH may receive a confirmation of the transaction as discussed in 302 of FIG. 1, which may indicate an amount in bitcoin. However, the third position may also be maintained in the U.S. dollar as discussed above. Thus, a treasury of the DCH may determine an amount in the U.S. dollar that was used to purchase the amount of bitcoin. As discussed above, the treasury may determine the amount in the U.S. dollar based on a user input or by requesting from cryptocurrency networks, such as the cryptocurrency networks 122. In either case, the treasury may generate a purchase indicating the amount in the U.S. dollar and transmit the purchase to the accounting of the DCH. The accounting of the DCH can then adjust the third position. For example, the third position may have $4,000 based on a prior purchase of one unit of bitcoin at a price of $4,000. The incoming transaction may involve purchasing one unit of bitcoin at a price of $ 6,000. Thus, instead of showing 2 units of bitcoins in the third position, the accounting of the DCH may adjust the third position to be $10,000. In some embodiments, the accounting of the DCH may create a new position for purchasing one unit of bitcoin at a price of $6,000. In other words, the later purchase of the one unit of bitcoin does not add to the prior position, such as the third position. In some embodiments, the accounting of the DCH may adjust the third position by adding a trading fee. For example, the trading fee may be $1.50. Thus, the accounting of the DCH may adjust the third position to $10,001.50. In some embodiments, the accounting of the DCH may determine how to adjust positions based on a book determined at 310. If the DCH determines more than one book at 310, the accounting of the DCH may adjust positions in each book in parallel. In some embodiments, the treasury of the DCH may indicate the trading fees in the purchase that are transmitted to the accounting of the DCH. Thus, the accounting of the DCH may further adjust the third position by adding the trading fees.

In some embodiments, if the transaction is an outgoing transaction in a native cryptocurrency, such as bitcoin, the accounting of the DCH may also adjust the third position and the fourth position. The accounting of the DCH may receive a confirmation of the transaction as discussed in 302 of FIG. 1, which may indicate an amount in bitcoin. The accounting of the DCH can then adjust the third position pro-rata. For example, the third position may have $4,000 based on a prior purchase of one unit of bitcoin at a price of $ 4,000. The outgoing transaction may involve selling 0.5 units of bitcoin. Because half of the third position was sold, the accounting of the DCH may adjust the third position to $2,000. On the other hand, the accounting of the DCH may adjust the fourth position by reducing it pro-rata based on the Network fee. Similarly as discussed above, the treasury of the DCH may determine an amount in the U.S. dollar that was received for selling the amount of bitcoin. The treasury may then generate a sale indicating the amount in the U.S. dollar and transmit the sale to the accounting of the DCH. In some embodiments, the accounting creates an additional transaction containing a gain or a loss. For example, the amount in the U.S. dollar maybe $3,000. In other words, the transaction may involve selling the 0.5 units of bitcoin at a unit price of $ 6,000. In such a case, the accounting of the DCH adjusts the third position to decrease $2,000 and adjusts the fourth position to increase $3,000, which results in a total net gain of $1,000.

At 408, the accounting of the DCH creates an accounting transaction based on the adjustments of the positions discussed in 406. In some embodiments, the accounting transaction may include the adjustments made in 406. The accounting transaction may also include the position snapshots created in 404. In some embodiments, the accounting of the DCH may create multiple accounting transactions. For example, the accounting of the DCH may create a first accounting transaction based on adjusting the first position discussed at 406. The accounting of the DCH may also create a second accounting transaction based on adjusting the second position discussed at 406. In some embodiments, the accounting of the DCH may aggregate the first and the second accounting transactions.

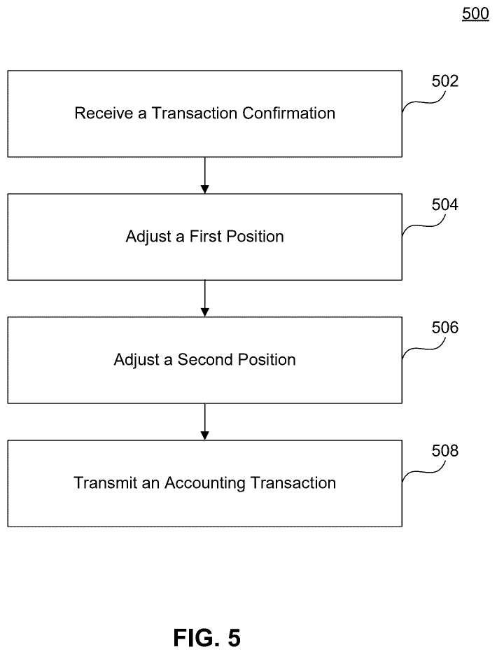

FIG. 5 illustrates an example method 500 of reporting a digital asset transaction, according to embodiments of the disclosure. As a convenience and not a limitation, FIG. 5 may be described with regard to elements of FIGS. 1, 2, and 6. The example method 500 may represent the operation of devices (e.g., the ERP system 102, the DCH 104, the digital asset management core 118, the DAC 120, the cryptocurrency networks 122, or a combination thereof of FIG. 1) enabling the ERP system to process digital assets transactions. The example method 500 may also be performed by computer system 600 of FIG. 6. But the example method 500 is not limited to the specific embodiments depicted in those figures and other systems may be used to perform the method, as will be understood by those skilled in the art. It is to be appreciated that not all operations may be needed, and the operations may not be performed in the same order as shown in FIG. 5.

At 502, a DCH, such as the DCH 104, receives a confirmation of a transaction. The confirmation indicates a first amount in a first cryptocurrency and a second amount in a second cryptocurrency. In some embodiments, the first cryptocurrency is a stable cryptocurrency, such as USDC or USDT, and the second cryptocurrency is a native cryptocurrency, such as bitcoin or ether.

At 504, the DCH adjusts a first position corresponding to the first cryptocurrency based on the first amount. In some embodiments, the first position is in a first book maintained by the DCH. As discussed above, the DCH may maintain a plurality of books corresponding to their respective regulations, such as US-GAAP, IFRS, or other local regulations. The DCH may determine that the transaction affects the book and then adjust the first position in the book. For example, the DCH may determine that the transaction is subject to the US-GAAP and the book follows the US-GAAP. In some embodiments, the DCH may take position snapshots prior to adjusting positions. For example, the DCH may take a first position snapshot of the first position prior to adjusting the first position.

At 506, the DCH adjusts a second position corresponding to the second cryptocurrency based on the second amount pro-rata. In some embodiments, the second position is also in the book discussed above. In addition, the DCH may take a second position snapshot of the second position prior to adjusting the second position. In some embodiments, to adjust the second position pro-rata, the DCH is configured to determine a current amount of the second cryptocurrency and determine a percentage between the second amount and the current amount. For example, the DCH may determine that the current amount of the second cryptocurrency is 1 unit of bitcoin. The DCH may further determines that the second amount is 0.2 units of bitcoin. Thus, the percentage between the second amount and the current amount is 0.2/1=20%. In some embodiments, the DCH further determine a current amount in a fiat currency of the second position. For example, the current amount in the fiat currency of the second position may be $20,000. Similarly as discussed above, this is because that the 1 unit of bitcoin was previously purchased at a price of $20,000. Finally, the DCH may deduct the current amount in the fiat currency of the second position by the percentage. For example, the DCH may deduct 20% from the $ 20,000. Thus, the second position is adjusted to $ 16,000, which is 80% of $20,000.

At 508, the DCH transmits an accounting transaction indicating adjusting the first position and the second position to an ERP system. In some embodiments, the accounting transaction may include the adjustments made in 504 and 506. The accounting transaction may also include the position snapshots discussed in 504 and 506. In some embodiments, the DCH may create a first accounting transaction based on the adjustments of the first position and a second accounting transaction based on the adjustments of the second position. The DCH may then create an aggregated accounting transaction and transmit it to the ERP system. The aggregated accounting transaction includes the first and the second accounting transactions.

In some embodiments, the Purchase or Sale created in 306 from treasury 108 is updated. For example, the update may include amounts that were previously entered or received. In either case, the DCH may process the update in similar fashions as discussed in the FIG. 5 as well as FIGS. 3 and 4. For example, the DCH may determine a book that is affected by the update. The DCH may then determine positions affected by the updates in the book. Furthermore, the DCH may determine or retrieve prior accounting transactions related to the positions in the book and create offsetting accounting transactions to revert changes made by the prior accounting transactions. Finally, the DCH may process the update similarly as discussed above FIGS. 3 and 4 and/or 504 and 506 of FIG. 5.

Various embodiments may be implemented, for example, using one or more well-known computer systems, such as computer system 600 shown in FIG. 6. One or more computer systems 600 may be used, for example, to implement any of the embodiments discussed herein, as well as combinations and sub-combinations thereof.

Computer system 600 may include one or more processors (also called central processing units, or CPUs), such as a processor 604. Processor 604 may be connected to a communication infrastructure or bus 606.

Computer system 600 may also include user input/output device(s) 603, such as monitors, keyboards, pointing devices, etc., which may communicate with communication infrastructure 606 through user input/output interface(s) 602.

One or more of processors 604 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 600 may also include a main or primary memory 608, such as random access memory (RAM). Main memory 608 may include one or more levels of cache. Main memory 608 may have stored therein control logic (i.e., computer software) and/or data.

Computer system 600 may also include one or more secondary storage devices or memory 610. Secondary memory 610 may include, for example, a hard disk drive 612 and/or a removable storage device or drive 614. Removable storage drive 614 may be a floppy disk drive, a magnetic tape drive, a compact disk drive, an optical storage device, tape backup device, and/or any other storage device/drive.

Removable storage drive 614 may interact with a removable storage unit 618. Removable storage unit 618 may include a computer usable or readable storage device having stored thereon computer software (control logic) and/or data. Removable storage unit 618 may be a floppy disk, magnetic tape, compact disk, DVD, optical storage disk, and/any other computer data storage device. Removable storage drive 614 may read from and/or write to removable storage unit 618.

Secondary memory 610 may include other means, devices, components, instrumentalities or other approaches for allowing computer programs and/or other instructions and/or data to be accessed by computer system 600. Such means, devices, components, instrumentalities or other approaches may include, for example, a removable storage unit 622 and an interface 620. Examples of the removable storage unit 622 and the interface 620 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 600 may further include a communication or network interface 624. Communication interface 624 may enable computer system 600 to communicate and interact with any combination of external devices, external networks, external entities, etc. (individually and collectively referenced by reference number 628). For example, communication interface 624 may allow computer system 600 to communicate with external or remote devices 628 over communications path 626, which may be wired and/or wireless (or a combination thereof), and which may include any combination of LANs, WANs, the Internet, etc. Control logic and/or data may be transmitted to and from computer system 600 via communication path 626.

Computer system 600 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 600 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 600 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 600, main memory 608, secondary memory 610, and removable storage units 618 and 622, as well as tangible articles of manufacture embodying any combination of the foregoing. Such control logic, when executed by one or more data processing devices (such as computer system 600), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 6. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A digital currency hub (DCH), comprising:
a memory; and
at least one processor coupled to the memory and configured to:
receive a confirmation of a transaction that indicates a first amount in a first cryptocurrency and a second amount in a second cryptocurrency;
adjust a first position corresponding to the first cryptocurrency based on the first amount;
adjust a second position corresponding to the second cryptocurrency based on the second amount pro-rata;
create a first accounting transaction based on the adjustments of the first position;
create a second accounting transaction based on the adjustments of the second position; and
transmit an aggregated accounting transaction including the first and the second accounting transactions to an enterprise resource planning (ERP) system.

2. The DCH of claim 1, wherein the at least one processor is further configured to:
determine a book based on an accounting regulation; and
adjust the first and the second positions in the book.

3. The DCH of claim 1, wherein to adjust the second position pro-rata, the at least one processor is further configured to:
determine a current amount of the second cryptocurrency;
determine a percentage between the second amount and the current amount;
determine a current amount in a fiat currency of the second position; and
deduct the current amount in the fiat currency of the second position by the percentage.

4. The DCH of claim 1, wherein the transaction is an outgoing transaction.

5. The DCH of claim 4,
wherein the first cryptocurrency is a stable cryptocurrency, and
wherein the second cryptocurrency is a native cryptocurrency.

6. The DCH of claim 1, wherein the at least one processor is further configured to:
take a first position snapshot of the first position; and
take a second position snapshot of the second position.

7. The DCH of claim 1, wherein the at least one processor is further configured to:
receive a second confirmation of a second transaction that indicates a transaction hash number, a third amount in the second cryptocurrency, and a wallet address;
determine a fourth amount in a fiat currency corresponding to the third amount in the second cryptocurrency and a trading fee;
adjust the second position based on the third amount pro-rata;
adjust a third position corresponding to the fiat currency based on the fourth amount; and
transmit a second accounting transaction indicating adjusting the first position and the third position to the ERP system.

8. The DCH of claim 7, wherein to determine the fourth amount, the at least one processor is further configured to:
transmit a query to a treasury, wherein the query indicates a hash number and/or a wallet address corresponding to the transaction; and
receive the fourth amount from the treasury.

9. A computer-implemented method for a digital currency hub (DCH), comprising:
receiving a confirmation of a transaction that indicates a first amount in a first cryptocurrency and a second amount in a second cryptocurrency;
adjusting a first position corresponding to the first cryptocurrency based on the first amount;
adjusting a second position corresponding to the second cryptocurrency based on the second amount pro-rata;
creating a first accounting transaction based on the adjustments of the first position;
creating a second accounting transaction based on the adjustments of the second position; and
transmitting an aggregated accounting transaction including the first and the second accounting transactions to an enterprise resource planning (ERP) system.

10. The computer-implemented method of claim 9, further comprises:
determining a book based on an accounting regulation; and
adjusting the first and the second positions in the book.

11. The computer-implemented method of claim 9, wherein adjusting the second position pro-rata further comprises:
determining a current amount of the second cryptocurrency;
determining a percentage between the second amount and the current amount;
determining a current amount in a fiat currency of the second position; and
deducting the current amount in the fiat currency of the second position by the percentage.

12. The computer-implemented method of claim 9,
wherein the first cryptocurrency is a stable cryptocurrency, and
wherein the second cryptocurrency is a native cryptocurrency.

13. The computer-implemented method of claim 9, further comprising:
receiving a second confirmation of a second transaction that indicates a transaction hash number, a third amount in the second cryptocurrency, and a wallet address;
determining a fourth amount in a fiat currency corresponding to the third amount in the second cryptocurrency and a trading fee;
adjusting the second position based on the third amount pro-rata;
adjusting a third position corresponding to the fiat currency based on the fourth amount;
and
transmitting a second accounting transaction indicating adjusting the first position and the third position to the ERP system.

14. The computer-implemented method of claim 13, wherein determining the fourth amount further comprises:
transmitting a query to a treasury, wherein the query indicates a hash number and/or a wallet address corresponding to the transaction; and
receiving the fourth amount from the treasury.

15. A non-transitory computer-readable medium (CRM) comprising instructions to, upon execution of the instructions by one or more processors of a digital currency hub (DCH), cause the DCH to perform operations, the operations comprising:
receiving a confirmation of a transaction that indicates a first amount in a first cryptocurrency and a second amount in a second cryptocurrency;
adjusting a first position corresponding to the first cryptocurrency based on the first amount;
adjusting a second position corresponding to the second cryptocurrency based on the second amount pro-rata;
creating a first accounting transaction based on the adjustments of the first position;
creating a second accounting transaction based on the adjustments of the second position; and
transmitting an aggregated accounting transaction including the first and the second accounting transactions to an enterprise resource planning (ERP) system.

16. The non-transitory CRM of claim 15, wherein the operations further comprise:
determining a book based on an accounting regulation; and
adjusting the first and the second positions in the book.

17. The non-transitory CRM of claim 15, wherein adjusting the second position pro-rata further comprises:
determining a current amount of the second cryptocurrency;
determining a percentage between the second amount and the current amount;
determining a current amount in a fiat currency of the second position; and
deducting the current amount in the fiat currency of the second position by the percentage.

18. The non-transitory CRM of claim 15,
wherein the first cryptocurrency is a stable cryptocurrency, and
wherein the second cryptocurrency is a native cryptocurrency.

19. The non-transitory CRM of claim 15, wherein the operations further comprise:
receiving a second confirmation of a second transaction that indicates a transaction hash number, a third amount in the second cryptocurrency, and a wallet address;
determining a fourth amount in a fiat currency corresponding to the third amount in the second cryptocurrency and a trading fee;
adjusting the second position based on the third amount pro-rata;
adjusting a third position corresponding to the fiat currency based on the fourth amount; and
transmitting a second accounting transaction indicating adjusting the first position and the third position to the ERP system.

20. The non-transitory CRM of claim 19, wherein determining the fourth amount further comprises:
transmitting a query to a treasury, wherein the query indicates a hash number and/or a wallet address corresponding to the transaction; and
receiving the fourth amount from the treasury.
